(19) United States
(12) Patent Application Publication
(10) Pub. No.: US 2007/0075644 A1
(43) Pub. Date: Apr. 5, 2007

(54) Bonding system, and a bonding system method for the fabrication of lamps

(76) Inventors: Ulrich Peuchert, Bodenheim (DE); Thilo Zachau, Burstadt-Riedrode (DE); Rohit Bhosale, Landshut (DE); Jorn Besinger, Landshut (DE); Dirk Sprenger, Stadecken-Elsheim (DE); Kurt Nattermann, Ockenheim (DE); Henk van Elst, Veenendaal (DE)

Correspondence Address: TAYLOR & AUST, P.C., 142 SOUTH MAIN STREET, P. O. BOX 560, AVILLA, IN, 46710, US

(21) Appl. No.: 11/521,174

(22) Filed: Sep. 14, 2006

(30) Foreign Application Priority Data
Sep. 30, 2005 (DE) 10 2005 047 006.8

(51) Int. Cl. H01J 61/12; H01J 17/20

(52) U.S. Cl. 313/637

(57) ABSTRACT

The invention relates to a bonding system method and for the fabrication of a bonding system, as well as to a light device formed using the method of the invention. The bonding of the two components which are to be joined, whereby at least one of the two components consists at least partially, preferably completely of glass or glass-ceramics, in other words of a glass-based material, is achieved by way of the following methods on their own merit. Through material sealing when utilizing an inorganic glass-based solder material or through sealing mechanisms without solder material by utilizing tensile stress and/or compressive strain conditions, at least in a high temperature range.

### BACKGROUND OF THE INVENTION

1. Field of the Invention

The invention relates to a bonding system, having at least two components, whereby at least one consists of glass or glass-ceramics, the invention also relates to a bonding system method for the fabrication of a lamp which includes an inventive bonding system.

2. Description of the Related Art

Lamps including a bulb element, preferably a glass bulb element, can be found in greatly different embodiments, in multiple application areas, and in many types of lamps. For example, in the field of general lighting or automobile lighting or in thermal radiators, such as halogen lamps, incandescent lamps, high pressure or low pressure discharge lamps. Lamps can also be utilized, especially in miniaturized form, in so-called “backlighting” in connection with the background lighting of flat panel screens. In conventional light sources, such as incandescent lamps, halogen bulbs and gas discharge lamps, the transparent bulbs, particularly glass or translucent ceramics bulbs are in either an elongated cylindrical or in a stout bulging shape.

What is needed in the art is an efficient economical bonding system for the formation of lamps.

### SUMMERY OF THE INVENTION

Lamps and applications are defined within the scope of one embodiment of the present invention whereby the bulb element is used as the first enveloping casing of the light emitting unit, for example the filament, and/or is used as a hermetically sealed body for inert or discharge gases. For the purpose of the present patent application these applications are referred to as “Type A” applications. This includes especially lamps of the “light bulb” or “halogen spot lamp” type where a current-carrying and therefore a highly heated tungsten spiral emits light, for example light bulbs or halogen spot lamps. In order to extend the life span as well as to increase the light yield, the bulbs in this type of lamp are filled with inert gases, such as krypton, argon or xenon. In the case of the halogen lamps the filler gases are halides which combine in the colder zones of the bulb interior with the tungsten which is volatilizing from the spiral and which disintegrates again on the hot tungsten spiral. The discharge of tungsten cause a “healing” on the hottest, that is the thinnest, areas of the spiral, thereby causing a life span extension. This is referred to as halogen circulation. The halogen additives also, practically completely, prevent blackening of the bulb through metal reflectors, and the inherent light current supply reduction since a condensation of metallic tungsten on the inside of the bulb is obviated through the formation of the tungsten halides. For this reason the bulb size can be greatly reduced and the filler gas pressure can be increased on halogen bulbs and the economic utilization of the inert gases krypton and xenon as filler gases is made possible.

In an alternative design of a Type A application the glass bulb forms the reaction space of a gas discharge. In addition, the glass bulb can act as carrier of light converting layers. Such lamps are, for example, low pressure fluorescent lamps as well as high pressure gas discharge lamps. In both instances supplied liquid or gaseous substances, frequently mercury (Hg), xenon (Xe) and/or neon (Ne), are stimulated to emit light, usually in the UV range, caused by an arc discharge between two electrodes which protrude into the bulb. In the instance of low pressure lamps, for example in back light lamps, the discrete UV lines are partially converted into visible lines thorough fluorescent layers. In medium pressure and high pressure discharge lamps the filler gases are put under high pressure of 100 bar or higher. Through impact effects as well as through formation of molecules, for example Hg, the discrete lines deteriorate into emission bands. The consequence of this is that quasi-white light is emitted. In addition there are optical active substances, for example halides of the noble earths, especially dysprosium halide or alkaline halides, which “complete” missing spectral components and increase the color fastness. The dependency of the white impression of the emitted light on the pressure is described in Derra et al. in “UHP-lamps: Light sources of extremely high brightness for projection television”, Phys. BI 54 (1998) No. 9 817-820. The disclosure content of this publication is included in its entirety as part of the disclosure content of the present application.

In “Type B” applications the glass bulb serves as a second enveloping casing, for example, for thermal encapsulation of the actual light emitting unit, as breakage or explosion protection, protection of materials and/or to protect the lamp user from harmful rays, especially UV rays.

Type B applications involve, for example, high pressure discharge lamps. The burners of high pressure discharge lamps, which are manufactured from silica glass or translucent ceramics (i.e. Al₂O₃, YAG-ceramics) are operated at the highest possible temperatures of up to 1000° C. or higher. The higher the operating temperatures are, the greater will be the color reproduction index and efficiency and at the same time decreasing the differences in light quality between individual lamps.

For the purpose of thermal insulation of the discharge vessel, a second enveloping glass bulb is inverted around the actual reaction body, whereby the space between them is mostly or essentially evacuated. In addition the enveloping bulb is doped with UV-blocking components.

Based on the different areas of application, different requirements present themselves regarding the utilized bulb glasses for Type A and Type B applications.

Type A applications require thermally highly stable materials, for example glasses which will not deform under the stresses caused by the close vicinity of the tungsten spiral or the high operating temperatures under pressure, especially the high pressure which occurs with the HID (High Intensity Discharge). In addition the glass bulbs are under an interior pressure of between 2 and 30 bar, in the case of halogen lamps or of up to approx. 100 bar or higher in the case of HID lamps. In addition, the bulbs must be highly chemically inert, in other words they must not react with the fillers. This means that no components from the bulb material may be released into the environment, especially no alkalis, OH ions or H₂O. In addition it is advantageous if the transparent materials can be permanently hermetically sealed with the feeder metals. The bulb materials should be sealed, especially with W- or Mo-metal or with Fe—Ni—Co alloys such as Kovar and/or Alloy 42. In addition, leadthroughs having been sealed in this manner are considered to be stable, even during temperature change cycles.

In comparison cold lamp types, such as low pressure lamps, are thermally stressed only to an insignificant extent in the area of the leadthroughs. However, if such low pressure lamps are utilized as “backlight” lamps, then special requirements arise regarding UV blocking.

“Backlight” lamps are low pressure discharge lamps which can be utilized in miniaturized form in TFT (thin film transistor) displays, for example screens, monitors, and TV units for backlighting. Previously, multi-component glass based on silicate was used for this purpose. When used as “backlight” lamps, high demands are made upon the shielding of UV-light through the glass of the lamp, since other components, especially synthetic components, quickly age and deteriorate in flat screens under the influence of UV radiation.

In Type B applications the demands upon the temperature ratings and upon the chemical composition/resistance are generally lower than in Type A applications. The prevailing temperatures on the outside bulb in an HID lamp are for example 300° C.-700° C., depending upon the distance of the hot spot of the burner from the bulb. Accordingly, the leadthrough area is clearly colder then the bulb volume immediately adjacent to the burner. Depending on the power output of the burner, and due to very small distances of the hot-spot from the bulb's inside wall, wall temperatures of up to 800° C., or higher, can occur. As previously described these bulbs should possess high UV-blocking capabilities, especially in “backlight” applications.

Materials being utilized for glass bulbs in Type A applications are, according to the current state of the art, soft glass for light bulbs, alkali-free hard glass for automobile halogen lamps or silica glass for halogen lamps or HID lamps for general lighting or studio lighting. In this regard we refer you to Heinz G. Pfaender; SCHOTT Glass Encyclopaedia, mvg-Publishers, pages 122-128, and also German patents DE 197 47 355 C1, DE 197 58 481 C1, DE 197 47 354 C1 whose disclosure contents are made a part of this application and are included in their entirety.

For highest efficiency discharge lamps, having translucent aluminum oxide, which will withstand temperatures of 1100° C. or higher is used under the current state of the art as an alternative to silica glass. Regarding highest efficiency discharge lamps we refer, for example, to European Patent No. EP 748 780 B1 or Krell et al: “Transparent sintered corundum with high hardness and strength” in J. Am. Ceram. Soc. 86(4) 546-553 (2003), the disclosure content of which is included in the current application in its.entirety.

The material used in low pressure lamps can in comparison be a soft glass, for example borosilicate glass.

The preferred material for glass bulbs in Type B applications is silica glass or multi-component glasses, for example, Suprax (i.e. SCHOTT Type 8655 or DURAN-glass by SCHOTT GLAS, Mainz).

The utilization, particularly of glass ceramics, in the construction of lamps is described for example, in Patent GB 1,139,622. This describes a composite lamp, consisting of a glass ceramic component, as well as a silica glass window. The components are bonded together with a Cu-containing solder-glass. No details are given in GB 1,139,622 regarding the production of green glass bulbs or bodies or as to their further processing. The range of application is restricted to UV and IR lighting.

In several of the lamp types, which are known according to the current state of the art, for example, halogen lamps or HID lamps, the inside and/or outside lamp bulb consists of silica glass. The leadthrough, when viewed from the outside toward the inside, consists of W- or Mo-wire which is welded to a Mo-foil having a thickness of <100 μm, as well as an additional weld point to a W-wire, which leads into the interior of the lamp, for example to the W-filament or to W-discharge electrodes.

It is a generally known procedure to produce cylindrical HID lamps by fusing the outside bulb with the contact wires. One of the disadvantages of this design is to be found in the size of the required fusion zone. In order to increase the compact design, and/or design freedom, of lights with HID lamps as a light source, the outside bulb is joined with a base plate containing the leadthrough wires, via a frit ring thereby reducing the size of the fusion zone. A design of this type is already known from the publication WO 2004/077490 A1. A discoid glass, ceramics or glass-ceramics base plate is joined together with a hollow body in the embodiment of a quartz glass, soft glass or hard glass bulb by means of a frit ring. The joint area is characterized by the face of the outside bulb facing the base plate, and its width and it progresses toroidally. The joint area of a reflector, in place of the bulb, which can be used in the production of a reflector lamp, in place of a bulb lamp, is likewise toroidal.

The designs for lighting devices known from the current state of the art are characterized by high manufacturing costs as well as high energy costs and/or are of a large size.

It is an objective of the current invention to overcome the disadvantages of the current state of the art. Especially methods which will permit production of lighting devices that distinguish themselves by great compactness. The process provides that the components forming the lamp or the lamp bulb are largely hermetically sealed with each other.

In accordance with one embodiment of the current invention the connection between two components that are to be bonded with each other, whereby at least one of the components includes at least partially, preferably totally, of glass or glass ceramics, that is a glass-based material that can be produced on its own accord by the following methods:
1) Through material sealing by utilization of an inorganic glass-based soldering material
2) Through sealing mechanisms free of soldering material by utilizing tension and/or pressure conditions, at least in the high temperature range.

In accordance with an especially advantageous design, both possibilities are combined, and in this instance a solder may be used.

The high temperature range is to be understood to be temperatures in the range of room temperature, that is approximately >50° C. to operating temperature of the lamp. In the case of HID lamps this is approx. 800° C. max. The low temperature range is characterized by temperatures≦room temperature or ≦50° C.

The first solution is characterized by the utilization of an inorganic glass-based solder material. Conventional Pb-borate composite glasses having the appropriate expansion reducing inert fillers can be used as soldering materials. Expansion adapted lead-free Bi—Zn borate composite glasses can also be used.

The connection of the individual components, which are to be joined with each other, whereby at least one of the components includes at least partially, preferably totally, of glass, glass ceramics or a glass-based material occurs through material sealing. This is characterized in that it is hermetically sealed and that it is stable at temperatures of up to T≧350° C., preferably T≧450° C. and preferably also as temperatures change.

The soldering process occurs by merging of the components that are to be joined through a diffusion process between the soldering material and the components which are to be joined. The melting temperature of the utilized soldering materials is to be below that of the melting temperature of the components which are to be joined, preferably in a range of 200° C. to 700° C. In an instance where a bulb/reflector is joined to a Fe—Ni-alloy (KOVAR, ALLOY42) this temperature should not exceed 600° C., ideally it should not be higher than 500° C.

The soldering process may be realized through the following cited methods:
a) Thermally, i.e. through radiant heaters
b) Through short-wave infrared radiation (sIR)
c) Through laser fusion
d) Through high frequency heating

The design according to b) incorporates optical fusing. Optical heating elements have the advantage of fusing glass gobs in a short time and locally, whereby the heating does not occur by way of surface heating and heat transport across the material itself, but occurs directly in the volume. This avoids thermally induced tensions in the glass gob, especially in thicker samples.

The state of the art for sIR is described in a series of publications. German Patent No. DE 199 38 807 describes the utilization of sIR radiation for the purpose of producing glass components from a glass gob, however, preferred use is for glass plates. German Patents DE 199 38 808, DE 199 38 811 as well as DE 101 18 260 describe the utilization of sIR radiation for the purpose of heating semi-transparent glass-ceramic source glasses, however, without reference to the joining between soldering material and the component which is to be connected.

The shape of the soldering material, in the initial state, will preferably be fitted to the shape of the components that are to be joined in the area of the joint, especially the joint surfaces. Dependent upon the type of the soldering material in its initial state, it is therefore possible to obtain locally very limited joining areas and thereby fusing areas.

In accordance with an especially advantageous embodiment of the present invention the material sealing is accomplished by way of soldering of the components in order to form a lamp bulb. This includes a first component in the form of a hollow body and a second component in the form of a discoid element. The hollow body is open, at least on one side. The opening is closed off by way of the discoid element. For this purpose, the discoid element is joined with the hollow body through the soldering material, whereby the connection is hermetically sealed. The discoid element may be a carrier for leadthroughs, especially metal leadthroughs. On the side of its opening, the hollow body has a surrounding surface, which is joined to the other component by inserting of the soldering material by way of material sealing. In the initial state the soldering material is then characterized by a toroidal shape.

Another inventive solution, in accordance with another embodiment of the present invention, is characterized in having compressive strain/tensile stress conditions between the interlocking components. These tensions are determined by the selection of the expansion coefficients of the individual components that are to be joined, their geometry and dimensioning, as well as their relative positioning to each other. Alternatively, or in addition, merely partial vacuum conditions may result in the formation of a positive hermetically tight joint without solder. Partial vacuum can, for example, be achieved through evacuation of a hollow space, formed by a discoid element, especially a plate and a hollow body in the form of a bulb/reflector, equipped with at least one opening. The evacuation may occur via a pump rod, for example a metal tube which is subsequently fused, for example, through laser heating.

A prerequisite for a connection without solder, by way of positive fitting under utilization of tensile stress/compressive strain conditions, is the dimensional accuracy of the source components prior to the actual joining process, especially regarding the plane-parallelism in the joint area of the components that are to be joined. This requires fitting precision with regard to
parallelism
gradient
concentricity
evenness
roundness
profile shape
surface roughness in the range of microns or fractions thereof.

In accordance with an advantageous further development of the present invention a material seal is created by using a soldering material between the components, which are to be joined together with a positive fit.

Depending on the form of the connection as well as the dimensioning of the components that are to be joined, components of identical or different materials in various combinations can be joined together. Utilization occurs independently of the type of connection, without solder material or with solder material. The possible applicable materials for the components that are to be joined are classified with respect to their thermal expansion coefficients (CTE) in ppm/K into the following expansion groups, which are identified according to type. Components of the same or of different types can be combined, irrespective of whether or not a solder material is used.

| | | |
|---|---|---|
| a) | Type 1: | Zero-expanding, or low expanding materials |
| | | 0 ≦ CTE_{20/300} ≦ 1.3 ppm/K |
| b) | Type 1Gr: | Gradient materials |
| | | 0 ≦ CTE_{20/300} ≦ 5 ppm/K whereby the subsequent |
| | | effective surface is low expanding, i.e. zero-expanding |
| c) | Type 2: | Materials having an expansion in the range of CTE_{20/300} |
| | | from 1.3 to 3.5 ppm/K |
| d) | Type 3: | Material having an expansion in the range of CTE_{20/300} |
| | | from 3.5 to 5.5 ppm/K |
| e) | Type 3Gr: | Gradient materials |
| | | 5 ≧ CTE_{20/300} ≧ 0 ppm/K whereby the subsequent |
| | | effective surface is high expanding, i.e. |
| | | CTE_{20/300} ˜4.0 ppm/K |
| f) | Type 4: | Materials having an expansion in the range of CTE_{20/300} |
| | | from 5.5 to 9 ppm/K |

Materials having a thermal expansion coefficient of CTE˜0 ppm/K are for example transparent lithium alumino-silicate (LAS) glass ceramics with the main crystal phase high quartz mixed crystal, such as ROBAX® or Zerodur® (Trademark of Schott Glas Mainz).

One example for a material having a CTE˜0.5/K is silica glass (SiO₂).

Materials having an expansion coefficient CTE˜1.0 ppm/K are, for example, translucent lithium alumino-silicate (LAS) glass ceramics with the main crystal phase Keatit mixed crystal.

Partially or locally ceramized lithium alumino-silicates (LAS) glass ceramic having a green glass area, especially a discoid, partially or locally, ceramized lithium alumino-silicate (LAS) glass ceramic having a ring-shaped outer glass ceramic bonding contact surface and a green glass area progressing radially inward can be utilized as gradient materials of Type 1 Gr. The material may have a composition from the following composition ranges (in weight-% on oxide basis)

| | |
|---|---|
| SiO₂ | 50-70 |
| Al₂O₃ | 17-27 |
| Li₂O | 0-5 |
| Na₂O | 0-5 |
| K₂O | 0-5 |
| MgO | 0-5 |
| ZnO | 0-5 |
| TiO₂ | 0-5 |
| ZrO₂ | 0-5 |
| Ta₂O₅ | 0-8 |
| BaO | 0-5 |
| SrO | 0-5 |
| P₂O₅ | 0-10 |
| Fe₂O₃ | 0-5 |
| CeO₂ | 0-5 |
| Bi₂O₃ | 0-3 |
| WO₃ | 0-3 |
| MoO₃ | 0-3 |

as well as conventional refining agents having a content of 0-4 weight %.

Transitional glasses of types 8228, 8229, 8230 of SCHOTT can be used as materials of Type 2, that is, having a CTE of between approximately 1.3 and 3.5 ppm/K. (also see DE 103 48 466)

| Oxide in (%) | 8228 | 8229 | 8230 |
|---|---|---|---|
| SiO₂ | 82.1 | 87.0 | 83.6 |
| B₂O₃ | 12.3 | 11.6 | 11.0 |
| Al₂O₃ | 5.3 | — | 2.5 |
| Na₂O | — | 1.4 | 2.2 |
| K₂O | — | — | 0.3 |
| Refining agents | 0.05-0.2 | 0.05-0.2 | 0.05-0.2 |
| α(×10⁶) | 1.3 | 2.0 | 2.7 |

DURAN 8330 (CTE=3.3 ppm/K) having an approximate composition of SiO₂ 81 weight %, B₂O₃ 12.8 weight %, Al₂O₃ 2.4 weight %, Na₂O 3.3 weight %, K₂O 0.5 weight % can also be used.

The glasses 8228, 8229, 8230 and 8330 encompass a glass composition range (weight %) of approximately 90% SiO₂, approximately 0% to approximately 10% A1203, approximately 0% to approximately 15% B₂O₃ and less than approximately 5% R₂O, whereby the content of Al₂O₃ and B₂O₃ together is approximately 7% to approximately 20% and R identifies an alkali metal of the group consisting of Li, Na, K, Rb and Cs.

As possible examples for materials having an expansion in the range of CTE_{20/300}=3.5 to 5.5 ppm/K (Type 3) the following materials may be used;
a) Iron-nickel-cobalt-alloys (Fe—Ni-Co-alloys), for example alloys such as Vacon 11® of CSR Holdings Inc., which is also referred to as “Kovar” or ALLOY 42. Depending upon the composition of the alloy (for example KOVAR or Alloy 42) expansion coefficients of between 3.5 ppm/K and 5.5 ppm/K are especially preferred for Fe—Ni-Co alloys.
b) Molybdenum metals or doped molybdenum having an expansion coefficient CTE of approximately 5.2 ppm/K
c) Tungsten or doped tungsten having a CTE of approximately 4.4 ppm/K
d) Hard glass, for example, glass having the SCHOTT designation 8253 with an approximate composition in weight %:

### EXAMPLE A1

| | |
|---|---|
| SiO₂ | 59.79 |
| Al₂O₃ | 16.52 |
| B₂O₃ | 0.30 |
| CaO | 13.52 |
| BaO | 7.86 |
| ZrO₂ | 1.00 |
| TiO₂ | 1.00 |
| Alpha_{20/300} | 4.73 ppm/K |
| Tg | 791° C. |
| Density | 2.66 g/cm3 |

e) Borosilicate, for example SUPRAX 8488 having a CTE_{20/300}˜4.3 ppm/K or 8250 having a CTE_{20/300}˜5.0 ppm/K
f) Source glass of lithium alumino-silicate (LAS) glass ceramic Type ROBAX® or Zerodur® (non-ceramized) having a CTE˜3.5-5.0 ppm/K

g) Magnesium alumino-silicate (MAS) glass ceramics having a composition from the following composition range (in weight % on oxide basis):

| SiO₂ | 35-70, particularly 35-60 |
|---|---|
| Al₂O₃ | 14-40, particularly 16.5-40 |
| MgO | 0-20, preferably 4-20, particularly 6-20 |
| ZnO | 0-15, preferably 0-9, particularly 0-4 |
| TiO₂ | 0-10, preferably 1-10 |
| ZrO₂ | 0-10, preferably 1-10 |
| Ta₂O₅ | 0-8, preferably 0-2 |
| BaO | 0-10, preferably 0-8 |
| CaO | 0-<8, preferably 0-5, particularly <0.1 |
| SrO | 0-5, preferably 0-4 |
| B₂O₃ | 0-10, preferably >4-10 |
| P₂O₅ | 0-10, preferably <4 |
| Fe₂O₃ | 0-5 |
| CeO₂ | 0-5 |
| Bi₂O₃ | 0-3 |
| WO₃ | 0-3 |
| MoO₃ | 0-3 |

as well as customary refining agents, for example SnO₂, CeO₂, SO₄, Cl, As₂O₃ Sb₂O₃ in volumes of 0-4 weight %.

Materials of Type 3Gr contain gradient materials having locally different heat expansion coefficients CTE_{20/300} of between 0 and 4 ppm/K. Such materials can be produced, for example, through suitable processes from source materials, such as raw glass of glass ceramic of the Type LAS. Depending on the design of the component, the element may be in the form of a hollow body (tubular, bulbous) or a disc. A design having a locally ceramized tubular element with a green area at the end is known from WO2005/066088.

Examples for materials having an expansion in the range of CTE_{20/300} of between 5.5 and 9.0 ppm/K are (Type 4):
a) Al₂O₃—ceramics 6≦CTE_{20/300}≦8 ppm/K
b) Lithium alumino-silicate glass ceramics with main crystal phase lithium—disilicate CTE_{20/300} approximately 9.0 ppm/K
c) Copper-clad Ni—Fe wire CTE_{20/300} axial 8.5 ppm/K
d) YAG ceramic CTE_{20/300} approximately 8 ppm/K

Hermetically tight bonding systems can be produced between material components from one expansion group as well as materials from different expansion groups.

Any inventive solution is applied in the fabrication of bonding systems with components where the first component is in the embodiment of a hollow body and the second component is a discoid element. Hollow bodies of glass or glass ceramics, for the production of lamps, may be in the form of tubes. If necessary, tubes can be converted into spherical or ellipsoid forms. Hollow spheres or hollow ellipsoids may, irrespective of a prior tubular form, also be produced directly through blowing or pressing.

Tubular glasses, glass ceramics, glasses or glass ceramics in a form that is similar to a tubular form can also be used as an outside bulb in HID (high intensity discharge) lamps, for example in high pressure metal halide, discharge lamps. In the present patent application “tubular” refers to a hollow body with an outer wall and at least one opening whose cross section is circular. In contrast, “similar to tubular” refers to the corresponding cross sections of another closed geometry, for example elliptic, oval or angular with rounded corners. Glasses and glass ceramics in the form of reflectors, which possess circular end surfaces in the area of the base, can also be joined with another material.

The present invention essentially refers to two different basic configurations. A choice can be made between these, depending upon the expansion regimen of the bonding partners and the geometric conditions of the lamp or the system.
at least free and unimpeded one-sided expansion of one of the components which are to be connected
limitation of the seating on both sides

Due to the continuously changing temperature conditions and especially contingent upon the activation and deactivation of the light devices, a hermetically tight seal must be assured in all operating conditions. Designs with the possibility of at least one-sided free seating for the creation of bonds from hollow bodies with an opening and discoid elements to close the opening are characterized in the following embodiments of the present invention with a view to the creation of a positive fit. All designs are intended for an embodiment of the hollow body, which provides a certain geometry describing the outside and inside circumference in the connection area, and an embodiment of the discoid element, preferably, however not imperatively (see below) with a protrusion on the face side with formation of a surface area describing the circumference of the protrusion for connection to the hollow body:
a) Features of the protrusion are in the form of
   a1) discoid protrusion
   a2) toroid protrusion in the area of the center line of the discoid element with a circumferential surface that is designed to be parallel or inclined toward the inside wall of the hollow body, whereby the geometry of the inside circumference of the hollow body is chosen to be similar, preferably with the fit being the same as that of the protrusion.
b) Design of the protrusion as a toroid protrusion in the area of the outside circumference of the discoid element that is to be parallel or inclined toward the outside wall of the hollow body, whereby the geometry of the outside circumference of the hollow body is chosen to be similar, preferably with the fit being the same as that of the outside circumference of the protrusion.
c) Design of a groove when two protrusions are provided, which form the effective surfaces for the connection, with a partial surface of the outside circumference and/or partial surface of the inside circumference of the hollow body.

The described configurations may be utilized without solder material or with solder material for the production of a bonding system. If no positive fit is required and the bonding is to occur essentially through material sealing, that is through solder, contouring of the plate may also be dispensed with, since the plate does not have any toroid, discoid or groove-type structure.

In addition, depending on the desired type of bonding, these are coordinated with each other in the low temperature condition with regard to the expansion coefficient and are dimensioned such that a transitional or press fit between the individual effective surfaces of the individual components exists, at least in the high temperature condition, especially in the operating condition of the lamp. Preferably this exists also in the low temperature range.

In order to increase the degree of freedom regarding the selection of materials of the individual components, which are to be connected with each other, they are geometrically coordinated with each other in such a way that a gap exists in the low temperature range between the effective surfaces, which are fitted positively with each other in the high temperature range. The gap geometry is determined with a regard to the selected materials and their expansion coefficients.

In order to avoid undesirable tension conditions the geometry of the effective surfaces and/or the gap is optimized to the extent where shear forces between the individual, actively associating, surfaces of the components that are to be connected are avoided to a great extent. This is realized by according soft, in other words rounded embodiments of the locating surface.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1a illustrates a bonding system in accordance with an embodiment of the present invention with a solder ring;

FIG. 1b illustrates with reference to Detail X according to FIG. 1a the location of the individual components relative to each other in the low temperature condition (room temperature);

FIG. 2a illustrates an inventive bonding system according to an embodiment of the present invention without solder material;

FIG. 2b illustrates with reference to Detail X according to FIG. 2a the location of the individual components relative to each other in the low temperature condition (room temperature);

FIG. 3a illustrates a bonding system according to another embodiment of the present invention with solder ring and radial gap;

FIG. 3b illustrates with reference to Detail X according to FIG. 3a the location of the individual components relative to each other in the low temperature condition (room temperature);

FIG. 4a illustrates an inventive bonding system according to another embodiment of the present invention according to FIG. 3 without solder material;

FIG. 4b illustrates with reference to Detail X according to FIG. 4a the location of the individual components relative each other in the low temperature condition (room temperature);

FIG. 5a illustrates an inventive bonding system according to another embodiment of the present invention according to FIG. 4 with optimized gap geometry;

FIG. 5b illustrates with reference to Detail X according to FIG. 5a the location of the individual components relative to each other in the low temperature condition (room temperature);

FIG. 5c illustrates the detail of FIG. 5b with the location of the components in the high temperature condition;

FIG. 6a illustrates an inventive bonding system with solder material according to another embodiment of the present invention;

FIG. 6b illustrates with reference to Detail X according to FIG. 6a the location of the individual components relative to each other in the low temperature condition (room temperature);

FIG. 7a illustrates a bonding system according to another embodiment of the present invention without solder material;

FIG. 7b illustrates with reference to Detail X according to FIG. 7a the location of the individual components relative to each other in the low temperature condition (room temperature);

FIG. 8a illustrates a bonding system according to another embodiment of the present invention with solder material;

FIG. 8b illustrates with reference to Detail X according to FIG. 8a the location of the individual components relative to each other in the low temperature condition (room temperature);

FIG. 9a illustrates a bonding system according to another embodiment with solder material and optimized gap geometry;

FIG. 9b illustrates with reference to Detail X according to FIG. 9a the location of the individual components relative to each other in the low temperature condition (room temperature);

FIG. 10a illustrates a bonding system according to another embodiment of the present invention;

FIG. 10b illustrates with reference to Detail X according to FIG. 10a the location of the individual components relative to each other in the low temperature condition (room temperature);

FIG. 11a illustrates a bonding system according to another embodiment of the present invention, with enlarged active surfaces compared with FIG. 10

FIG. 11b illustrates with reference to Detail X according to FIG. 11a the location of the individual components relative to each other in the low temperature condition (room temperature);

FIG. 12a illustrates a bonding system according to a further embodiment of the present invention with optimized solder material application;

FIG. 12b illustrates with reference to Detail X according to FIG. 12a the location of the individual components relative to each other in the low temperature condition (room temperature).

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE PREFERRED EMBODIMENT

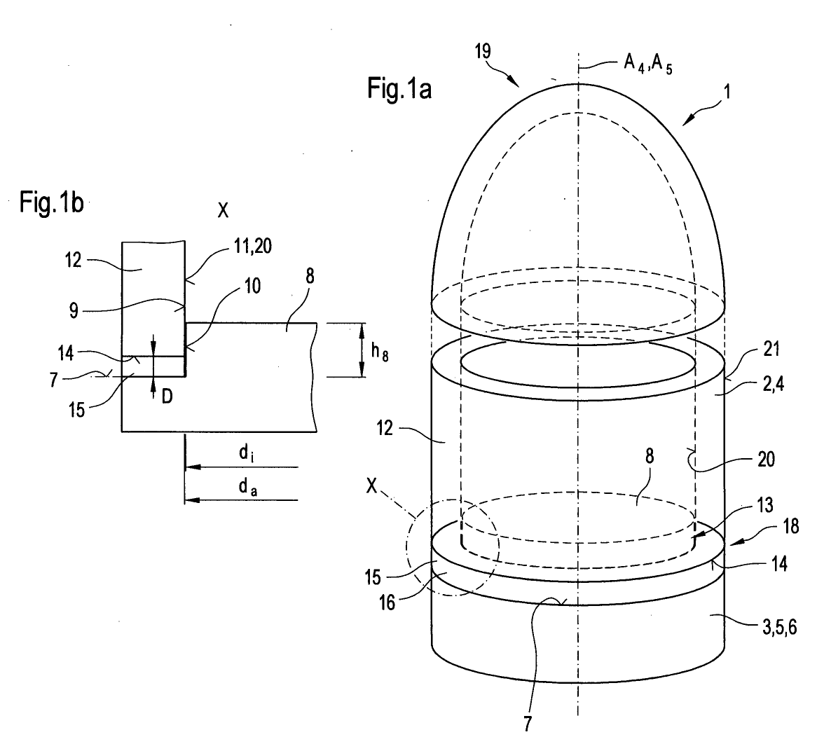

Referring now to the drawings, and more particularly to FIGS. 1a through 12a there is schematically shown simplified illustrations of bonding systems, and FIGS. 1b through 12b show the location relationships of the individual components, which are to be connected with each other, including a first component 2 and a second component 3 with the assistance of a detail of a sectional view in the low temperature condition, or in other words at room temperature. Component 2 is constructed as a hollow body 4 and component 3 as a discoid element 5 in the form of a base plate 6. At least one component consists, at least partially, of glass or glass ceramic.

The preferred application for connection system 1 is in lamps or lights, whereby a hollow body 4 forms a bulb and a base plate 6 the bottom with leadthroughs for electrodes.

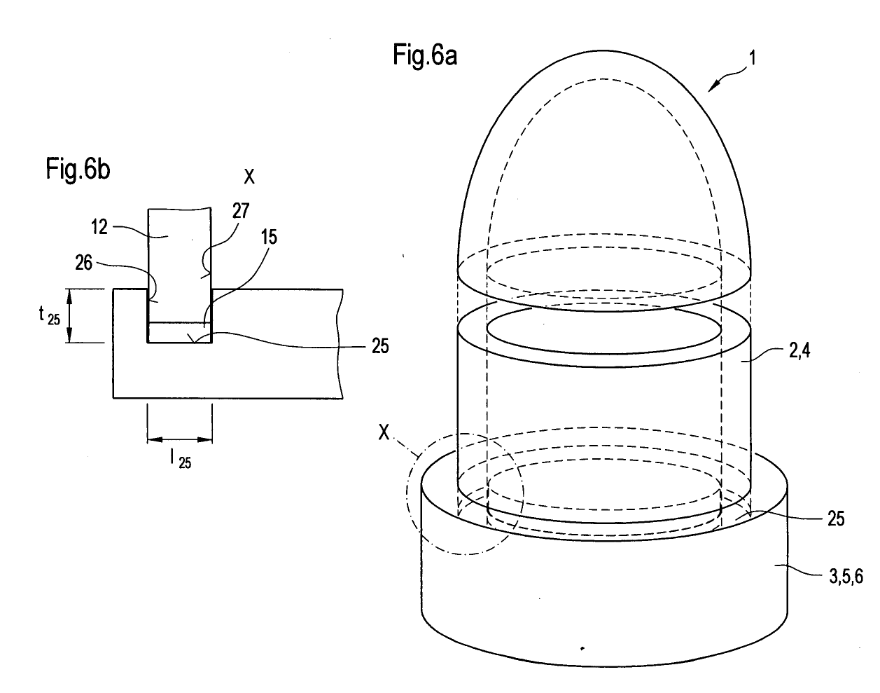

The bonding systems, in accordance with FIGS. 1 through 5, are characterized by a geometric embodiment of the individual components, which are to be connected with each other, and do not exhibit a one-sided limitation of hollow body 4 for seating, while the embodiments according to FIGS. 6 through 12 are characterized through two-sided fixing.

FIG. 1 illustrates an embodiment of an inventive bonding system 1, including a discoid element 5 and a hollow body 4. FIG. 1a illustrates bonding system 1. FIG. 1b illustrates a sectional view of an axial section from FIG. 1a. Hollow body 4, with reference to an axis A4, is constructed, preferably rotationally, symmetrically and possesses a first hollow cylindrical partial section which, at its end area 18 is open and which, at its other end area 19 is closed, whereby the closure occurs through a second dome-shaped or ellipsoidal partial section, which is constructed as a single component with the first component. Formed hollow body 4 is characterized by an inside surface 20, an outside surface 21 as well as a face 14. The connection between components 2 and 3, according to FIG. 1, is accomplished through a positive fit and material sealing. In its bonded condition, discoid element 5 provides a protrusion 8 facing toward the direction of face side 7 of hollow body 4. Protrusion 8 aids the positive fit between hollow body 4 and discoid element 5. The positive fit is created through interaction of the effective surface 9 on protrusion 8 and effective surface 10 on inside circumference 11 of inside surface 20 of wall 12 of hollow body 4 in the connection area.

Protrusion 8 may be in various embodiments and it possesses an effective surface 9 facing an inside circumference 11 of wall 12 of hollow body 4, preferably parallel to it. This means that the geometry of protrusion 8 and the area of wall 12 of hollow body 4, which represents an effective surface 10, are to be coordinated regarding their fit. In the illustrated example, hollow body 4 is characterized by at least one rotational symmetrical design in the connection area to base plate 6. Effective surface 10 as a partial surface of inside surface 20 of the hollow body 4 is therefore toroidal. The complementary effective surface 9 on protrusion 8 is also a toroid and arranged at an angle, preferably vertical to face 7. Depending upon the individual embodiment, this toroid surface in the form of effective surface 9 is formed either by a toroid, or in the illustrated example a discoid protrusion 8. The dimensions of protrusion 8 in circumferential direction in a rotational-symmetric design according to an axis A5, which when components 2 and 3 are connected, coincides with axis A4 of hollow body 4, are smaller in radial direction than those of base plate 6. Preferably both are characterized by a diameter of the inside circumference 20 of hollow body 4 in the connecting area by a diameter dᵢ and an outside diameter of protrusion 8 by a diameter dₐ. Depending on the design, surface area 16 remaining between both diameters on face 7 serves as a direct contact surface for hollow body 4, especially face 14 or as illustrated in FIG. 1a serves as a connection with face 14 through a solder ring 15. Surface area 16 and face 14 do not necessarily have to be of the same size. In other words outside wall 21 of hollow body 4 need not necessarily be in alignment with the outside edge of the plate (not illustrated). A projection of the plate is possible, while a projection of the outside wall of the hollow body should be avoided.

The components, which are fitted together in this way, hollow body 4 and base plate 6, form a pair of effective surfaces 13 in the connection area, especially in the radial direction. In addition, face 14 of hollow body 4, which is facing base plate 6, is connected with surface area 16 of face 7 on base plate 6 through a solder material, especially a solder ring 15, providing a positive fit. The solder material further serves to fill the remaining leakages. The size of the joint is determined by the dimensions of solder ring 15, as well as the behavior of the solder material in its liquid state. Because of its only one-sided positive fit, hollow body 4 has no one-sided limitations, that is, limitations on outside circumference 21 for seating in a radial direction, in order words pointing away from effective surface 9 on protrusion 8. The solder ring is matched regarding its dimensioning, especially regarding its diameter and its width viewed cross directionally, with the dimensions of face 14 of hollow body 4. Thickness D, viewed cross directionally is less than height h8 of protrusion 8 relative to face 7.

According to FIG. 1, the individual components of bonding system 1 are characterized by identical or insignificantly different thermal expansion coefficients CTE. This applies to hollow body 4, discoid element 5 and solder ring 15, in other words CTE_{B}˜CTE_{H}˜CTE_{Solder}.

The individual components are designed and sized such that the fit in the joining area is dimensioned for positive locking, that is, between protrusion 8 and inside circumference 11 of wall 12 it is dimensioned at least as a transitional fit, and preferably forms a press fit already in the low temperature condition, or in other words at room temperature.

Face 7 and surface area 16 are preferably flat and at an angle of 90° to symmetrical axis A5 of base plate 6, and A4 of hollow body 4.

In the embodiment according to FIG. 1a and 1b the positive fit occurs in a radial direction relative to symmetrical axis A4 and A5 of hollow body 4 and base plate 6. In a vertical direction, in other words parallel to symmetrical axis A4 and A5 the connection is realized through material sealing through a solder material in the form of solder ring 15. The fusing zone on the connecting components 2 and 3 can therefore be kept minimal depending on the dimension of solder ring 15, especially due to its width B, since only a ring-shaped or circulatory area is affected.

For example, the following material combinations, which have been categorized according to their expansion coefficient, find a use in the construction of bonding system 1, according to FIG. 1, at least in the connection area for the individual components, which are to be combined. The examples in FIGS. 1-12 are to be regarded as representative for all other cited materials within one expansion group:

Example 1: Provides the first or second components from a material of the Type 1 group with CTE of between 4 and 0 ppm/K, whereby the zone with a CTE=4 ppm/K is in the connection area of the components and the components which are to be connected to them from a material of the Type 3 group having expansions in the range of CTE=3.5 to 5.5 ppm/K.

Example 2: Provides both components from a material of Type 3 with expansions in the range of CTE_{20/300}=3.5 to 5.5 ppm/K.

Material Examples for Individual Components 2 and 3 for the Connections are:
a) (ref. example 1) first or second component, preferably component 2 of partially ceramized LAS glass ceramics second or first component, preferably component 3 of Alloy 42 or KOVAR
b) (ref. example 2) first or second component, preferably component 2 of MAS-glass ceramics second or first component, preferably component 3 of KOVAR or Alloy 42
c) (ref. example 2) first or second component, preferably component 2 of hard glass, second or first component, preferably component 3 of KOVAR or Alloy 42
d) (ref. example 2) first or second component, preferably component 2 of Borosilicate glass, for example Schott Type 8488, second or first component, preferably component 3 of Alloy 42 or KOVAR

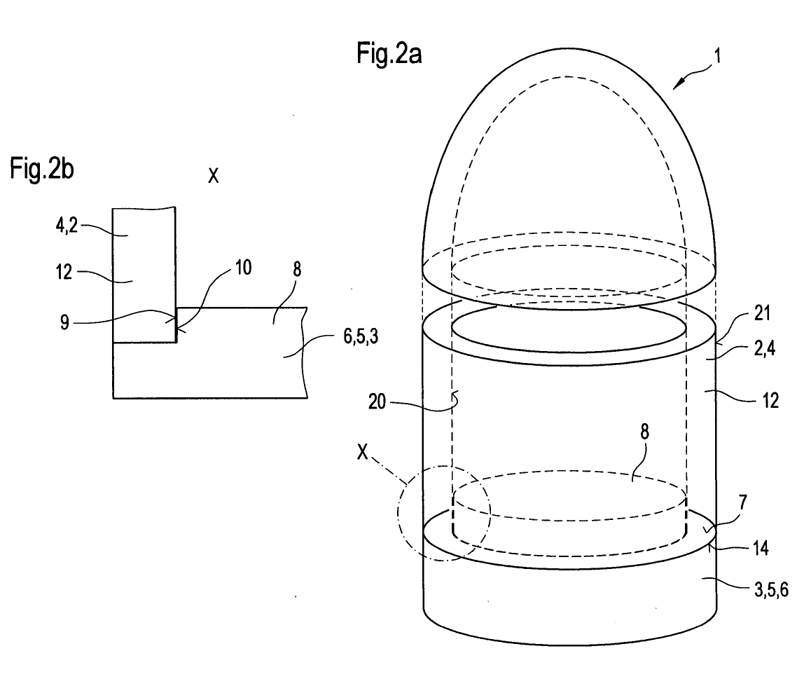

In contrast, FIG. 2 illustrates a design according to FIG. 1 without solder material. In this example the bond between individual components 2 and 3 is accomplished through positive fitting, on the basis of utilization of the tension and a partial vacuum condition prevailing during heating and cooling, or cooling and heating, or evacuation. The basic construction of bonding system 1, especially of individual components 2 and 3 is consistent with that which is described in FIG. 1, with no solder material provided between face area 14 of hollow body 4 and face area 7 on base plate 6. The bond occurs solely through positive fitting. The prerequisite for this is the utilization of materials having approximately the same thermal heat expansion between the components which are to be fitted together, in other words CTE_{H}˜CTE_{B}.

For example, the following material combinations for the individual components which are to be connected can be used, at least in the connection area in one embodiment of bonding system 1 according to FIG. 2:
Example 1: Provides first and second component from a zero- or low-expanding material having a thermal expansion CTE of between 0 and 1.3 ppm/K
Example 2: Provides a component from a material with expansions in the range of CTE=3.5 to 5.5 ppm/K and the other component from a zero- or low-expanding material.

Material Examples for Individual Components 2 and 3 of the Joints:
a) First or second component, preferably component 2, from silica glass second or first component, preferably component 3 from translucent LAS-glass ceramic with the main crystal phase Keatite-mixed crystal

The optimum fit dimensions are dependent upon the CTE of the components, the respective temperature and the then occurring E-moduli and transversal contraction values of the materials. It is generally accepted that the transverse stresses, which are permitted to act upon the enveloping bulb, should be limited to a maximum of 15 MPa, preferably <10 MPa. The following applies approximately:
Tension (<10 MPa)=(E(T)·γ)/2·(1+ν(T)))
with: E(T): E-modulus at respective temperature
   sin γ=2·(initial radius of the grove)·(1+CTE(T))/(depth of the groove)
ν(T): Poisson-value at respective temperature

The optimum depth of the groove and its radius can then be determined.

If materials having the same heat expansion are used for components 2 and 3 the build-up of a compressive strain occurs opposite the inside wall of hollow body 4, due to the expansion of protrusion 8 of base plate 6 in a radial direction and due to the expansion of hollow body 4, with hollow body 4 also expanding again in the radial direction. At least a hermetically tight connection is created in the area of effective surfaces 9 and 10 in a radial direction and due to the progression of the effective surfaces, in a vertical direction, by way of form fitting. In addition, a hermetically close fit occurs between surface 14 facing base plate 6 and ring-shaped surface area 16.

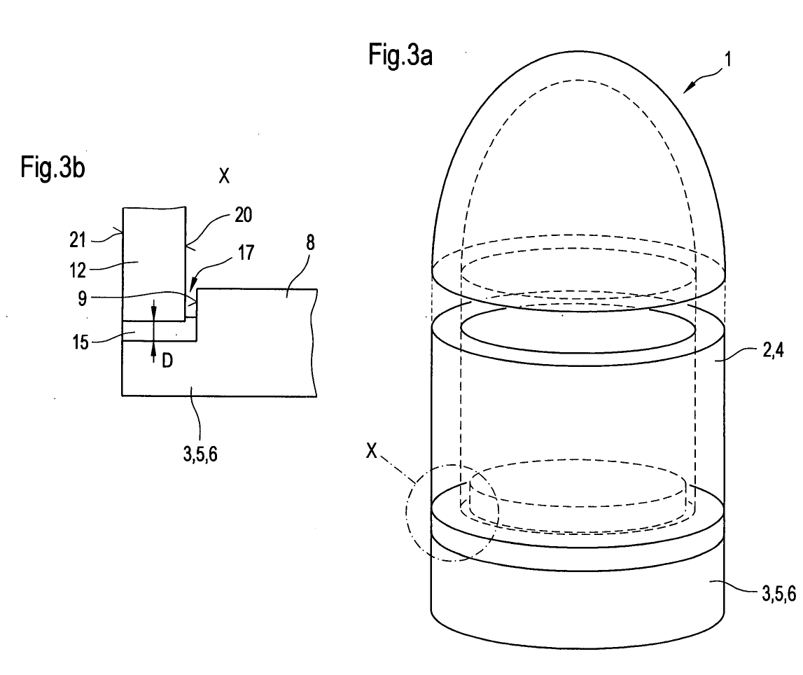

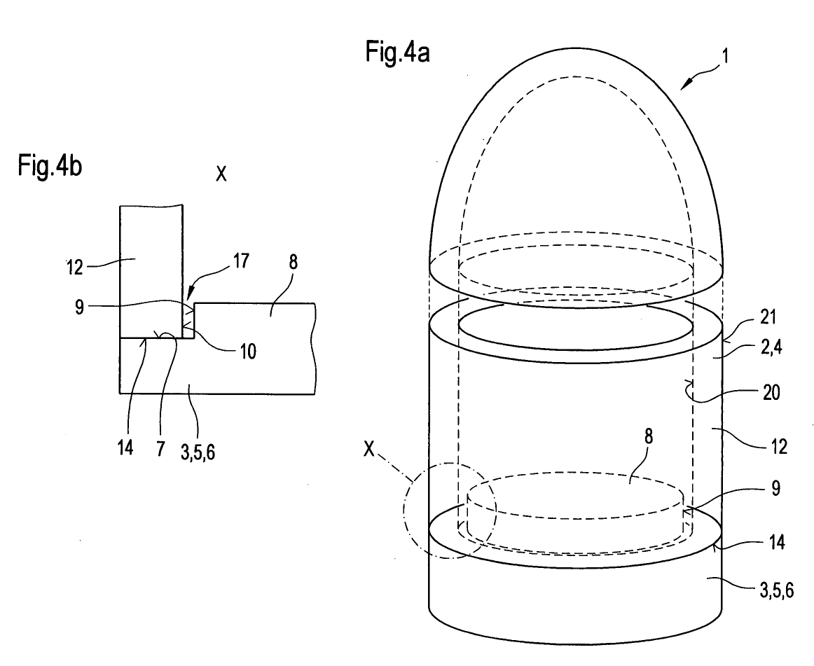

FIGS. 3 and 4 respectively illustrate further details of the present invention than shown in FIGS. 1 and 2. These are characterized by the provision of a radial gap 17 between effective surfaces 9 and 10 of components 2 and 3 in the low temperature condition of bonding system 1, that is at temperatures <50°, preferably at room temperature or lower. The gap size in the radial direction is in the range of 0.001 to 0.2 R, where R=radius of hollow body 4.

FIG. 3 illustrate further details of another embodiment of the present invention with solder ring 15 and a gap 17, which exists at least in the low temperature condition. Gap 17 is provided between inside wall 20 of hollow body 4 and protrusion 8 of base plate 6. Gap 17 progresses toroidally around effective surface 9, which is created by protrusion 8 and is located between this and the surface area on inside circumference 11 or inside surface 20 of hollow body 4, which acts as an effective surface 10 in the high temperature condition. Solder ring 15 is located between face 14 of hollow body 4, which faces toward base plate 6 and face 7 of base plate 6 and further extends into gap 17, both in a radial and a vertical direction. This design permits utilization of materials from different expansion groups for components 2 and 3 which are to be bonded with each other. The thermal expansion coefficient is CTE_{H}≦CTE_{B}, whereby the solder material compensates for these different expansion coefficients in that the solder material's expansion coefficient is preferable intermediary and/or is provided in an appropriate thickness D. Through the adaptation of the bonding partners, solders are also possible whose expansion is within a certain range above or below those of the bonding partners. The disparity in the expansion coefficients should preferably not exceed 1 ppm/K.

The bonding of components 2 and 3 occurs under all operational conditions, especially at almost all temperatures at least by way of material sealing. In addition, positive fitting is also possible in the high temperature range.

For example, in one embodiment of bonding system 1, according to FIG. 3 the following materials, which are characterized through categorization into expansion groups, can be utilized, at least in the connection area of the individual components, which are to be joined.

Example 1: Provides the first or the second component from a zero or low-expanding material having 0≦CTE≦1.3 ppm/K and provides the second or first component from a material having expansions in the range of CTE between and including 3.5 to and including 5.5 ppm/K

Example 2: Provides the first or second component from a gradient material having CTEs of between 4 and 0 ppm/K (range of higher thermal expansions in the connecting area and the components, which are to be connected with them from a material having expansions in the range of CTE=3.5 to 5.5 ppm/K.)

Example 3: Provides both components from a material having expansions in the range of CTE=3.5 to 5.5 ppm/K.

Material Examples for Individual Components 2 and 3 of the Joints:
a) First or second component, preferably component 2 of partially ceramized LAS glass ceramic or LAS glass ceramic with high quartz mixed crystal, second or first component, preferably component 3 of Alloy 42 or KOVAR.
b) First or second component, preferably component 2 of MAS-glass ceramic second or first component, preferably component 3 of KOVAR or Alloy 42.
c) First or second component, preferably component 2 of hard glass, for example Schott Type 8253, second or first component, preferably component 3 of KOVAR or Alloy 42.
d) First or second component, preferably component 2 of borosilicate glass, for example Schott Type 8488 (SUPRAX), second or first component, preferably component 3 of Alloy 42 or KOVAR.
e) Both components of hard glass, for example Schott Type 8253
f) First and second component of borosilicate glass, for example preferably component 2 of Schott Type 8488 (SUPRAX), Second or first component, preferably component 3 of glass Type 8250.

Relative to solder materials, conventional Pb-borate composite type glasses with suitable expansion reducing inert fillers can be used. Expansion-adapted lead-free Bi—Zn composite glasses or glasses on a phosphate basis can also be used.

Especially utilized were solder materials having the following characteristics:

Solder A (CTE_{20/300}˜4.4 ppm/K; Tg˜325° C.; T_{Solder}: 440° C.) or

Solder B (CTE_{20/300}˜5.6 ppm/K; Tg˜445° C.; T_{Solder}: 540° C.-570° C.)

In contrast, FIG. 4 illustrates an embodiment according to FIG. 3 without solder material, especially solder ring 15. In this example, face 14 of hollow body 4 is in direct contact with face 7 of base plate 6. In the low temperature condition inside circumference 20, in other words effective surface 10 is separated through toroidal gap 17 in a radial direction from effective surface 9 on basis plate 6. In the high temperature condition the connection occurs through positive fitting. Here the thermal expansion coefficient is CTE_{H}≦CTE_{B}.

For example in one embodiment of bonding system 1 according to FIG. 4 the following materials, which are characterized through categorization into expansion groups can be utilized, at least in the connection area of the individual components which are to be joined

Example 1 Provides the first or second component from a material having expansions in the range of CTE=3.5 to 0.5 ppm/K and the second or first component from a material having expansions in the range of CTE=5.5 to ppm/K.

Material Example for Individual Components 2 and 3 of the Joints:

First or second component, preferably component 2 of borosilicate glass, for example Schott Type 8488 (SUPRAX), second or first component, preferably component 3 of AIOX

Example 2 Provides the first or second component from a material having expansions in the range of CTE=0 to 1.3 ppm/K and the second or first component from a material having expansions in the range of CTE=3.5 to 5.5 ppm/K.

Material Example:

First or second component, preferably component 2 of LAS glass ceramic, for example Schott ROBAX, second or first component, preferably component 3 of KOVAR.

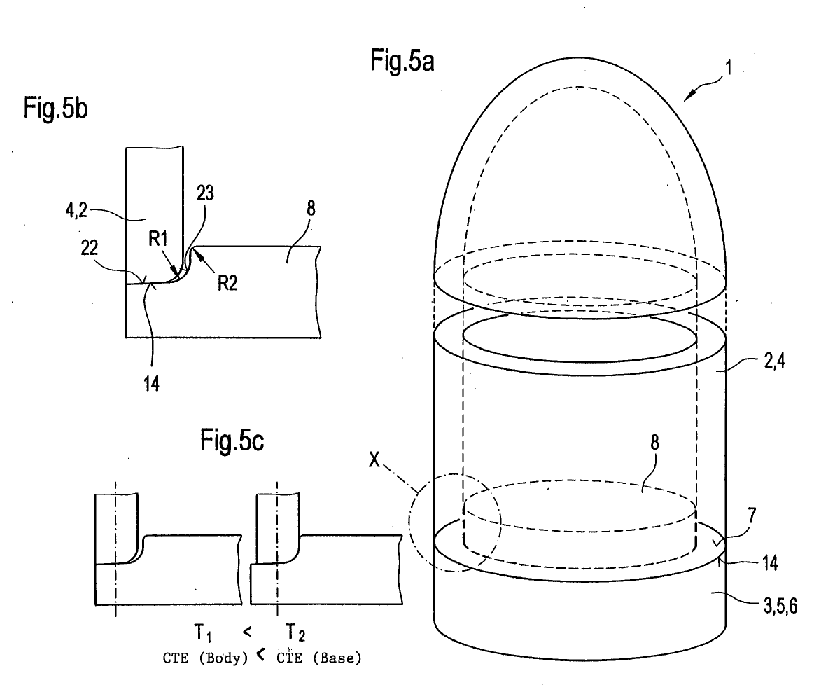

FIG. 5 illustrates an embodiment according to FIG. 4 with optimized gap geometry. Base plate 6 possesses a greater expansion coefficient than hollow body 4. Hollow body 4 consists preferably of a zero-expanding material. Moreover, the design of face 14 on hollow body 4 is determined by the shape of base plate 6 in the high temperature condition, especially the transition between the outside circumference of base plate 6 and protrusion 8. This is curved and can be described by a radius, preferably by a multitude of radii.

FIG. 5b illustrates bonding system 1 in the low temperature state, while FIG. 5c illustrates these conditions in the high temperature state.

Originating from the outside circumference on base plate 6 a flat surface area 22 extends to and joins the curved transitional area 23. The curvature is S-shaped and can be described by at least two radii R1 and R2 which are aligned opposite each other.

Since the geometry of hollow body 4 in the bonding area is adapted to that of the protrusion in the high temperature condition so that a flat contact of inside wall 20 of hollow body 4 with at least a partial surface of the outside circumference of protrusion 8 is assured in the high temperature condition, a flat fit in the area of outside circumference 24 of base plate 6 occurs only at room temperature. Gap 17 is characterized by different dimensions over its progression in radial and vertical directions. Shear forces, which would be exerted by base plate 6 upon hollow body 4 due to the expansion during heating, are kept to a minimum or are totally eliminated by this embodiment. In the low temperature condition the contact surface between base plate 6 and hollow body 4, especially face 14 is a flat surface according to FIG. 5b, which can be slanted relative to the center line of joint 1, in other words axis A4 or A5 by 5 to 30°. The dimension of the contact surface will be determined by the requirement of the tightness of the hermetic seal, which should also be assured at room temperature. Also, in a high temperature condition the inside surface of hollow body 4 is in S-shaped contact on base plate 6. Sliding movements of base plate 6 relative to hollow body 4 are unavoidable during heating and cooling. However, a hermetic seal is assured through the selection of small shape and position tolerances and low static friction and sliding friction coefficients, preferably μ<0.1 across the entire operational temperature range.

For example, in one embodiment of bonding system 1 according to FIG. 5 the following materials, which are characterized through categorization into expansion groups can be utilized, at least in the connection area of the individual components, which are to be joined

Example 1: Provides the first or second component from a material having expansions in the range of CTE=3.5 to 0.5 ppm/K and the second or first component from a material having expansions in the range of CTE=1.3 to 3.5 to ppm/K.

A material Example for Individual Components 2 and 3 of the Joints:
a) First or second component, preferably component 2 of glass, Schott Type 8228, second or first component, preferably component 2 of KOVAR

FIGS. 6, 7, 8, 10, 11 and 12 illustrate examples, according to one of FIGS. 1 through 4, whereby the expansion of the hollow body in a radial direction is limited on both sides. For this purpose base plate 6 is designed with a groove 25. Groove 25 is located in the area of outside diameter dA6 of base plate 6 and progresses toroidally at a distance from outside diameter dA6. Depending upon the design, especially the dimensions of groove 25, the bonding between the individual components in bonding system 1 is accomplished by positive fitting or through a combination of material sealing and positive fitting.

FIG. 6 illustrates an embodiment depicting the connection of hollow body 4 to base plate 6 through material sealing by way of a solder ring 15 and, at least in the high temperature condition by way of positive fitting based on the expansion of individual components 2 and 3. Groove 25 is characterized by a depth dimension t₂₅ and a width dimension B₂₅ which, in the room temperature condition, assures a flat fit of hollow body 4 with its inside and outside surface in the immersion area of groove 25 as well as with the inner and outer groove walls 26 and 27 and which additionally also contains solder ring 15. Depth t₂₅ preferably measures 0.5 to 5 times width B₂₅ or 1.5 to three times the solder ring thickness D. Width dimension B₂₅ corresponds with a tolerance in the range of 0.01 to 1% to the thickness of wall 12 of hollow body 4 in the connection area.

In this embodiment the expansion coefficients of individual components 2 and 3 and those of the solder material are coordinated with each other, being consistent with CTE_{H}˜CTE_{B}˜CRE_{Solder}

For example, in one embodiment of bonding system 1 according to FIG. 6 the following material combinations can be utilized, at least in the connection area of the individual components, which are to be joined:

Example 1: Provides the first or second component in a gradient material having a CTE of between 4 and 0 ppm/K and the components which are to be joined in a material with expansions in the range of CTE=3.5 to 5.5 ppm/K.

Example 2: Provides both components being a material with expansions in the range of CTE=3.5 to 5.5 ppm/K.

Material Examples for Individual Components 2 and 3 of the Joints:
a) First or second component, preferably component 2 of partially ceramized LAS glass ceramic, second or first component, preferably component 3 of Alloy 42.
b) First or second component, preferably component 2 of MAS glass ceramic, second or first component, preferably component 3 of KOVAR or Alloy 42.

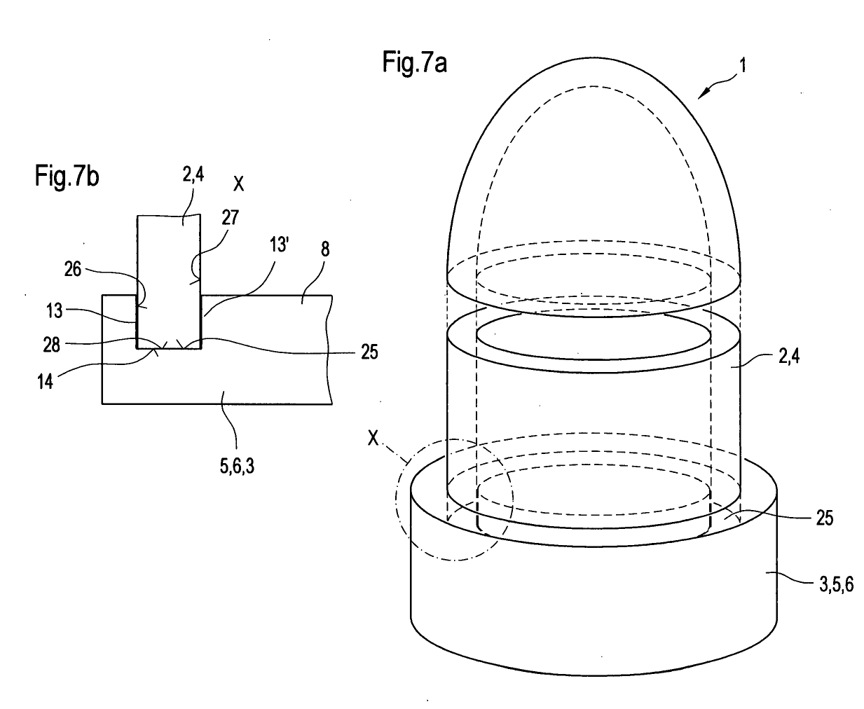

In contrast, FIG. 7 illustrates an embodiment according to FIG. 6 without solder material. In this instance the bonding of individual components 2 and 3 is established by positive fitting alone through utilization of the tension conditions or partial vacuum prevailing during heating and cooling. The basic composition of bonding system 1, especially of individual components 2 and 3 corresponds with that described in FIG. 1, whereby no solder material is provided between face 14 of hollow body 4 and face 7 on base plate 6, which are in contact with each other. The bonding is established merely through positive fitting. A prerequisite for this is the utilization of materials which have approximately the same thermal heat expansion between the components, which are to be joined, that is CTE_{H}˜CTE_{B}.

Groove 25 contains wall 12 of hollow body 4. Groove walls 26 and 27, which face in a radial direction, together with outside surface 21 of hollow body 4 and inside surface 20, respectively form an effective surface pair 13 and 13′. Face 14 of hollow body 4 is in contact with groove floor 28. During heating a pressure build-up occurs upon wall 12 of hollow body 4.

For example, in one embodiment of bonding system 1 according to FIG. 7 the following material combinations can be utilized, at least in the connection area of the individual components, which are to be joined:

Example 1: Provides the first and second component in a zero- or low-expansion material having a thermal expansion of between CTE 0 and 1.3 ppm/K

A material example for individual components 2 and 3 of the joints are first and second components of silica glass

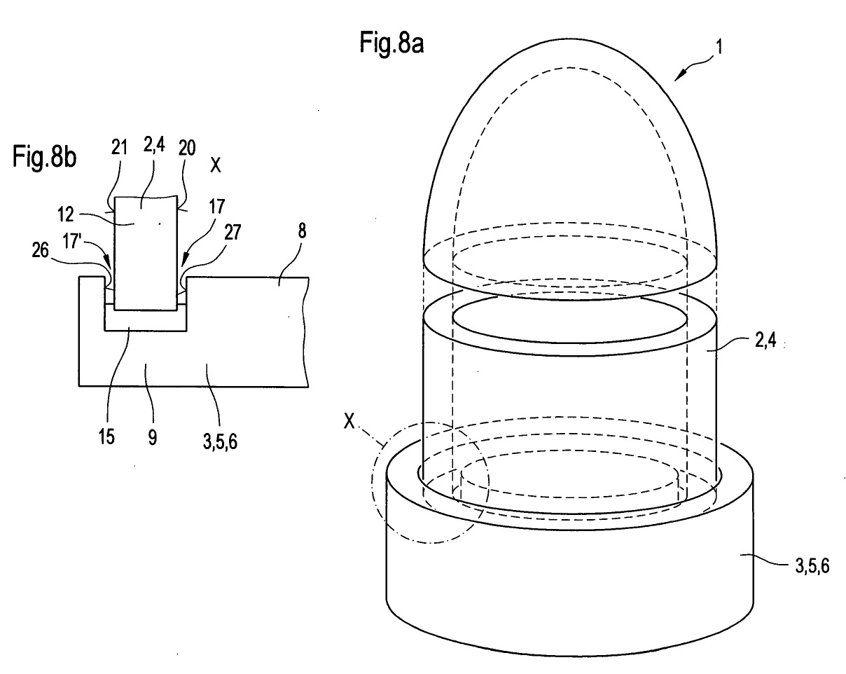

In contrast, FIG. 8 illustrates an embodiment according to FIG. 6 with gaps 17 and 17′ on each side, and solder ring 15. In the low temperature condition groove 25 is characterized by a width dimension B₂₅ which is by several % greater than the wall thickness of wall 12 of hollow body 4 in this temperature condition. This causes the formation of a first radial gap 17 in the low temperature condition, between effective surface 9, which is formed between inside surface 20 and protrusion 8, which is consistent with inner groove wall 27 and second groove 17′ between outside surface 21 of hollow body 4 and radial outer groove wall 26.

Hollow body 4 does not make contact with face 14 to groove floor 29, but instead is connected to it by way of solder ring 15. At the same time solder ring 15 fills up gap 17 and 17′, at least partially, vertically relative to the radial direction.

The example, according to FIG. 8, also permits utilization of materials having different heat expansion coefficients. The differences are compensated for by the solder material, resulting in CTE_{H}≦CTE_{B}, whereby CTE_{Solder}≦CTE_{B} or CTE_{Solder}≧CTE_{B}.

The connection is always through material sealing. In addition, a positive fit can be produced in the high temperature condition by virtue of the dimensioning of the components which are to be connected with each other.

For example, in one embodiment of bonding system 1 according to FIG. 8 the following material combinations can be utilized, at least in the connection area of the individual components, which are to be joined:

Example 1: Provides the first or second component being of a gradient material having a CTE of between 4 and 0 ppm/K and the components, which are to be joined, of a material with expansions in the range of CTE=3.5 to 5.5 ppm/K.

A material example for individual components 2 and 3 of the joints are the First or second component, preferably component 2 being of partially ceramized LAS glass ceramic, and second or first component, preferably component 3 being Alloy 42.

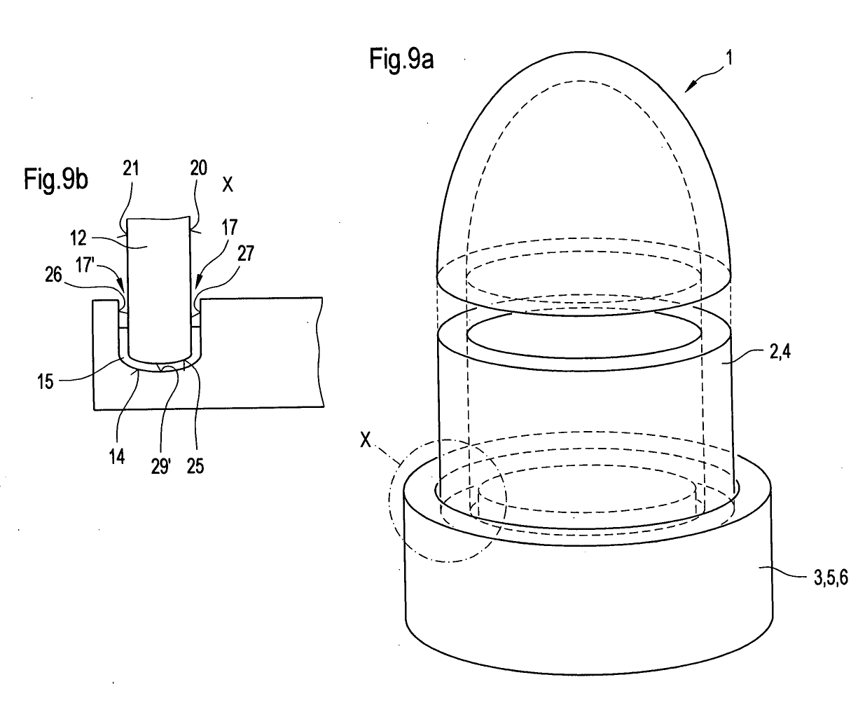

FIG. 9 illustrates an example according to FIG. 8 with rounded groove floor configuration. As a result of the curved groove floor and the preferably also curved transitions to groove walls 26 and 27 the tensions are distributed more homogenously. Face 14 of hollow body 4 is adapted to the configuration of groove floor 29. In other words, it is also rounded in its configuration. The same prerequisites apply for the selection of the materials for the individual components with regard to thermal expansion.

The connection is always through material sealing. In addition, a positive fit can be produced in the high temperature condition by virtue of the dimensioning of the components which are to be connected with each other.

For example, in one embodiment of bonding system 1 according to FIG. 9 the following material combinations can be utilized, at least in the bonding location of the individual components, which are to be joined:

Example 1: Provides the first or second component being a gradient material having a CTE of between 4 and 0 ppm/K, and the components which are to be joined being of a material with expansions in the range of CTE=0 to 1.3 ppm/K.

Material example for individual components 2 and 3 of the joints are First or second component, preferably component 2 being of partially ceramized LAS glass ceramic hQMK and the second or the first component, preferably component 3 of LAS glass ceramic.

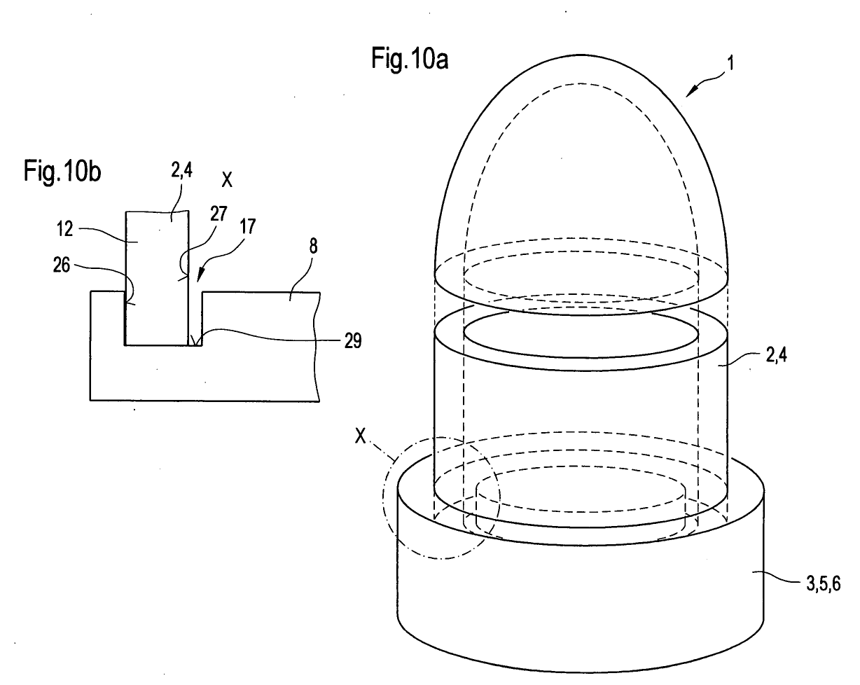

In contrast, FIG. 10 illustrates an example, according to FIG. 7 with a gap 17 on one side, between protrusion 8 and inside circumference 20 of hollow body 4. This progresses toroidally between hollow body 4 and protrusion 8.

For example, the following materials, which are characterized through categorization into expansion groups, can be utilized, at least in the bonding area of the individual components, which are to be joined in one embodiment of bonding system 1 according to FIG. 10:

Example 1: Provides the first or second component being a material having expansions in the range of CTE=1.3 to 3.5 ppm/K and the various components, which are to be joined with them, from a material having expansions in the range of CTE=5.5 to 9.0 ppm/K.

Material example for individual components 2 and 3 of the joints are the First or second component, preferably component 2 being of a transitional glass 8228, the second or first component, preferably component 3 being DUMET

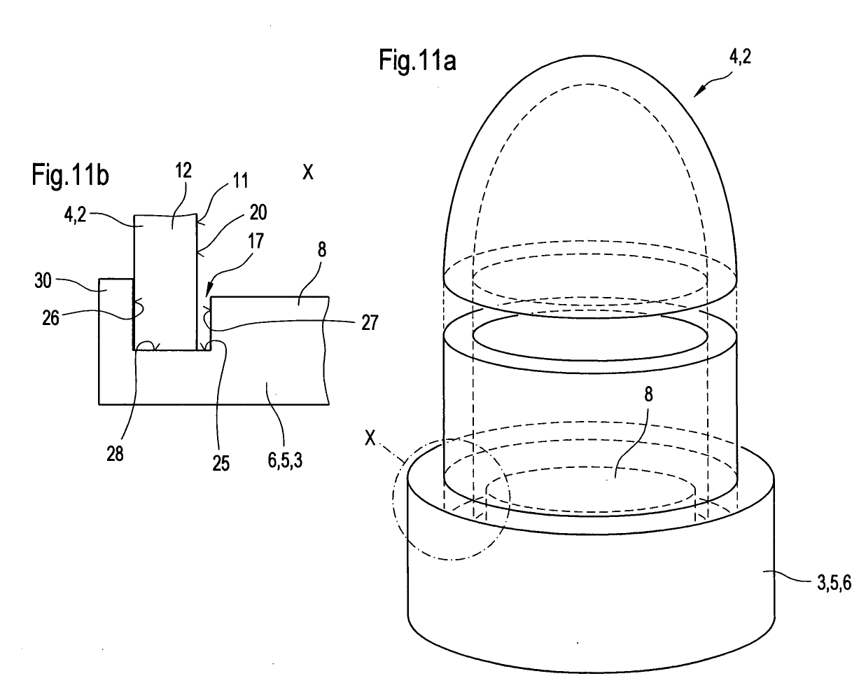

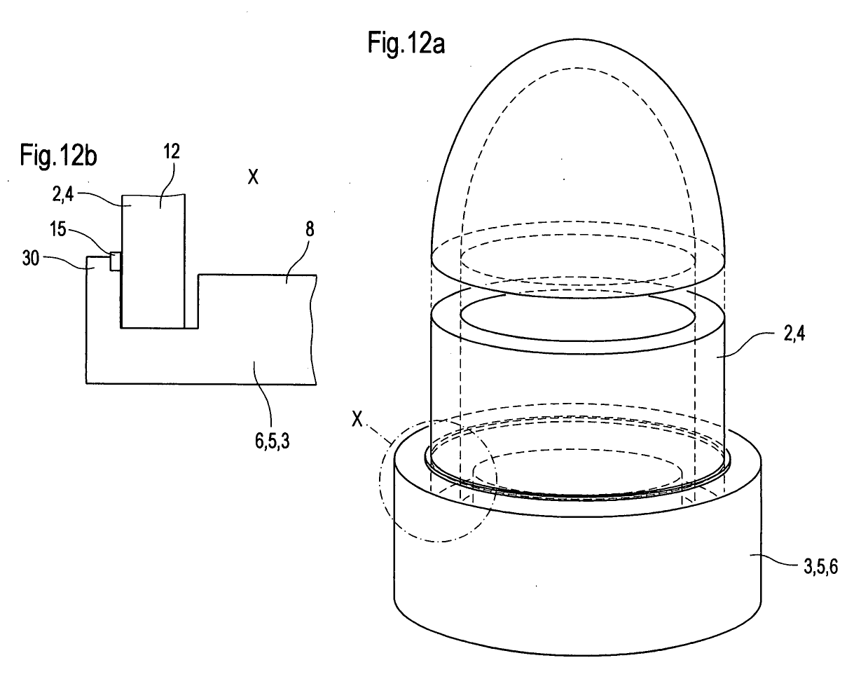

In an additional design form, according to FIGS. 11 and 12 base plate 6 is shrunk onto hollow body 4 in the embodiment of a lamp vessel. The lamp vessel possesses, for example, zero thermal expansion. Base plate 6 consists of a positive expanding metal alloy. Base plate 6 includes a ring-shaped groove 25 in the form of an annular gap progressing in circumferential direction, that is at a distance from the outside circumference of base plate 6 whose opening width b₂₅, is greater than the thickness of wall 12 of hollow body 4, so that a gap 17 is formed on one side, between wall 12 and the outside diameter of protrusion 8 on base plate 6. The outside diameter dA25 of the annular gap is adapted to the thermal expansion of the base plate material, so that it is precisely consistent with outside diameter dA4 of hollow body 4, especially the lamp vessel at the operating temperature of the lamp. Consequently, base plate flange 30 exerts pressure upon the lamp vessel at room temperature, thereby sealing it hermetically. To the extent that greater process tolerances are to be made possible, which no longer assure hermetic tightness of the shrink connection, a solder ring can additionally be provided. The material clearance that has to be exhibited by flange 30 of base plate 6, as well as the lamp vessel, that is hollow body 4, in order to absorb the pressures, which occur due to the shrink-on process, are determined by the CTE difference of the utilized material and can be calculated.

In the low temperature range, in an embodiment according to FIG. 10, an almost tension free state is assumed. In contrast, in an embodiment according to FIG. 11, pressure is exerted upon hollow body 4, due to the shrink-on process. Hollow body 4 in FIG. 10 is under compressive strain in the area of the groove in the high temperature range. Hollow body 4 in FIG. 11 is almost tension free.

For example, the following materials, which are characterized through categorization into expansion groups can be utilized, at least in the bonding area of the individual components, which are to be joined in one embodiment of bonding system 1 according to FIGS. 11 or 12:

Example 1: Provides the first or second component being of from a material having expansions in the range of CTE=0-1.3 ppm/K and the components which are to be joined with them being of a material having expansions in the range of CTE=3.5 to 5.5 ppm/K.

Material Example for Individual Components 2 and 3 of the Joints:
a) The first or second component, preferably component 2 being a LAS glass ceramic with high quartz mixed crystal phase second or first component, preferably component 3 being of KOVAR or Alloy 42
b) The first or second component, preferably component 2 being of silica glass, second or first component, preferably component 3 being KOVAR or Alloy 42

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claim.

Component Identification

1 Bonding system
2 first component
3 second component
4 hollow body
5 discoid element
6 base plate
7 face on base body facing toward the hollow body
8 protrusion
9 effective surface
10 effective surface
11 inside circumference
12 wall
13 effective surface pair
14 face
15 solder ring
16 surface area
17 gap
18 first end area
19 second end area
20 inside surface
21 outside surface
22 surface area
23 transition area
24 outside circumference
25 groove
26 groove wall
27 groove wall
28 groove floor
29 curved groove floor
30 flange
da outside diameter of the protrusion on the base plate
di inside diameter of the hollow body
dA6 outside diameter of the base plate
dA4 outside diameter of the hollow body
B₂₅ width
t₂₅ depth

What is claimed is:

1. A bonding system, comprising:
a solder material; and
a plurality of components including a first component and a second component, at least one of said first component and said second component consists at least partially of at least one of glass and glass-ceramics, said first component and said second component have a connecting area and are material-sealed forming a bond in said connecting area by way of said solder material, said solder material being inorganic and glass-based, said bond being hermetically tight and stable to temperatures of one of greater than and equal to 350° C.

2. The bonding system of claim 1, wherein said bond is stable to temperatures of one of greater than and equal to 450° C.

3. The bonding system of claim 1, wherein at least one of said first component and said second component consists completely of one of glass and glass-ceramics.

4. A bonding system, comprising a plurality of components including a first component and a second component, at least one of said first component and said second component consisting at least partially of one of glass and glass-ceramics, said first component and said second component being joined with each other in a bonding area by way of a sealing mechanism at least in a high temperature range defined as one of greater than and equal to 50° C., said sealing mechanism being created by tension conditions in said bonding area.

5. The bonding system of claim 4, wherein said first component is a hollow body having an opening, said second component being a sealing element for said opening, a partial vacuum being provided between said hollow body and said sealing element.

6. The bonding system of claim 5, wherein said sealing mechanism is a positive fit between said hollow body and said sealing element.

7. The bonding system of claim 6, wherein said positive fit is created between effective surfaces of said first component and said second component.

8. The bonding system of claim 5, wherein said hollow body and said sealing element are connected without solder material.

9. The bonding system of claim 5, wherein said hollow body and said sealing element are joined with each other by way of a material-seal.

10. The bonding system of claim 9, further comprising a solder material, said material-seal includes a soldered joint using said solder material, said solder material being inorganic and glass-based, said bond which is achieved by way of said soldered joint being hermetically tight and stable to temperatures of one of greater than and equal to 350° C.

11. The bonding system of claim 10, wherein said soldered joint is stable to temperatures of one of greater than and equal to 450° C.

12. The bonding system of claim 6, wherein said positive fit is created by thermal expansion of said hollow body and said sealing element which are joined together.

13. The bonding system of claim 12, wherein said hollow body and said sealing element each have an effective surface in said bonding area, said effective surfaces having a geometry and dimensions such that they provide at least one of a transitional fit and a press fit at least in said high temperature range.

14. The bonding system of claim 12, wherein said hollow body and said sealing element each have an effective surface in said bonding area, said effective surfaces having a geometry and dimensions such that they provide at least one of a transitional fit and a press fit at least in a low temperature range defined as less than 50° C.

15. The bonding system of claim 4, wherein said first component and said second component consist of materials each having a coefficient of thermal expansion (CTE) that are substantially the same.

16. The bonding system of claim 15, wherein said CTE of said first component and said second component consist of one of a zero expanding and a low expanding material, said low expanding material being defined as having a thermal expansion coefficient of 0≦CTE20/300≦1.3 ppm/K.

17. The bonding system of claim 4, wherein said first component and said second component consist of a gradient material having a thermal expansion coefficient of 0≦CTE_{20/300}≦5 ppm/K, said second component having a CTE_{20/300} of substantially zero.

18. The bonding system of claim 4, wherein said first component and said second component consist of materials having expansions in the range of CTE_{20/300}=1.3 to and including 3.5 ppm/K.

19. The bonding system of claim 4, wherein said first component and said second component consist of materials having thermal expansion coefficients in the range of CTE_{20/300}=3.5 to and including 5.5 ppm/K.

20. The bonding system of claim 4, wherein said first component and said second component consist of gradient materials having a thermal expansion coefficient of including 5>CTE_{20/300}≧0 ppm/K.

21. The bonding system of claim 20, wherein said second component has a CTE_{20/300} of approximately 4.0 ppm/K.

22. The bonding system of claim 4, wherein said first component and said second component consist of materials having thermal expansion coefficients in the range of CTE_{20/300}=5.5 to and including 9 ppm/K.

23. The bonding system of claim 4, wherein said first component and said second component consist of materials which have different thermal expansion coefficients (CTE).

24. The bonding system of claim 23, wherein at least one of said first component and said second component consists of material having a thermal expansion coefficient of 0≦CTE_{20/300}≦1.3 ppm/K.

25. The bonding system of claim 23, wherein at least one of said first component and said second component consists of a gradient material having a thermal expansion coefficient of 0≦CTE_{20/300}≦5 ppm/K, said second component having an effective surface with an approximately zero thermal expansion coefficient.

26. The bonding system of claim 23, wherein at least one of said first component and said second component consists of a material having a thermal expansion coefficients in the range of CTE_{20/300}=1.3 to and including 3.5 ppm/K.

27. The bonding system of claim 23, wherein at least one of said first component and said second component consists of a material having a thermal expansion coefficients in the range of CTE_{20/300}=3.5 to and including 5.5 ppm/K.

28. The bonding system of claim 23, wherein at least one of said first component and said second component consists of a gradient material having a thermal expansion coefficient of 5≧CTE_{20/300}≧0 ppm/K, said second component having an effective surface with a CTE_{20/300} of approximately 4.0 ppm/K.

29. The bonding system of claim 23, wherein at least one of said first component and said second component consists of a material having a thermal expansion coefficients in the range of CTE_{20/300}=5.5 to and including 9 ppm/K.

30. The bonding system of claim 4, wherein said first component is a hollow body, said second component being a discoid element, said discoid element having a surface with at least one of a discoid and a toroid protrusion, said surface facing toward said hollow body.

31. The bonding system of claim 30, wherein said protrusion is located in a center area of said discoid element, said hollow body having an inside circumference in a bonding area that is one of equal to and larger than an outside circumference of said protrusion.

32. The bonding system of claim 31, wherein at least a partial area of said outside circumference of said protrusion and at least a partial area of said inside circumference of said hollow body are at least indirectly joined effective surfaces.

33. The bonding system of claim 31, wherein an annular gap exists in the low temperature condition being defined as less than 50° C. between said hollow body and said outside circumference of said protrusion.

34. The bonding system of claim 31, wherein said protrusion is in the form of a toroid protrusion in the area of said outside circumference of said discoid element, one of an inside diameter and outside diameter of said hollow body in said bonding area being one of equal to and larger than an outside diameter of said toroid protrusion

35. The bonding system of claim 31, wherein said protrusion is in the form of a toroid protrusion in the area of said outside circumference of said discoid element, an outside diameter of said hollow body in said bonding area being one of equal to and smaller than an inside diameter of said toroid protrusion.

36. The bonding system of claim 34, wherein a gap exists between said hollow body and said protrusion at less than 50° C.

37. The bonding system of claim 30, wherein said discoid element includes two protrusions by the formation of at least one of a groove and a flange, said two protrusions having one of equal and different heights compared to a face of said discoid element.

38. The bonding system of claim 30, wherein said hollow body is a bulb being open on one side.

39. The bonding system of claim 30, wherein said hollow body is one of a bulb and a toroid element.

40. The bonding system of claim 10, wherein said solder material is a Pb-borate composite glass.

41. The bonding system of claim 10 , wherein said solder material is a Bi—Zn-borate composite glass.

42. The bonding system of claim 10, wherein said solder material includes phosphate based composite glasses.

43. A method for the fabrication of a bonding system, comprising the steps of:
positioning a first component and a second component relative to each other;
placing a solder material between bonding surfaces of said first component and said second component; and
heating said solder material by one of thermal transfer, short-wave infrared radiation (sIR), laser fusion and high frequency heating.

44. The method of claim 43, wherein a hollow space created between said first component and said second component is evacuated.

45. A method for the fabrication of a bonding system, comprising the step of positioning a first component and a second component relative to each other such that a positive fit is created as a function of at least one of geometric dimensions and material selection in a bonding area between said first component and said second component.

46. A light device, using a bonding system comprising:
a solder material; and
a plurality of components including a first component and a second component, at least one of said first component and said second component consists at least partially of at least one of glass and glass-ceramics, said first component and said second component have a connecting area and are material-sealed forming a bond in said connecting area by way of said solder material, said solder material being inorganic and glass-based, said bond being hermetically tight and stable to temperatures of one of greater than and equal to 350° C.

47. A light device, using a bonding system comprising:
a plurality of components including a first component and a second component, at least one of said first component and said second component consisting at least partially of one of glass and glass-ceramics, said first component and said second component being joined with each other in a bonding area by way of a sealing mechanism at least in a high temperature range defined as one of greater than and equal to 50° C., said sealing mechanism being created by tension conditions in said bonding area.

48. The light device of claim 47, wherein the light device is a thermal radiator.

49. The light device of claim 48, wherein the thermal radiator is one of a light bulb and a halogen lamp.

50. The light device of claim 47, wherein a primary light emission of the thermal radiator occurs through a heated tungsten metal or tungsten alloy helix which is surrounded by inert gases.

51. The light device of claim 50, wherein said inert gases include at least one of krypton, argon, xenon or halides.

52. The light device of claim 50, wherein during operation of the light device an internal gas pressure of up to 25 bar is built up in the interior of the body of the light device.

53. The light device of claim 47, wherein the light device is a discharge lamp.

54. The light device of claim 53, wherein the discharge lamp includes a discharge chamber and the discharge chamber is filled with discharge substances including at least one of mercury, rare earth ions and xenon.

55. The light device of claim 54, wherein the discharge chamber includes a discharge body.

56. The light device of claim 55, further comprising a fluorescent coating applied to the inside of said discharge body which converts UV components from a discharge process, including UV components from mercury into visible light.

57. The light device of claim 55, wherein said body includes a filler gas that is under pressure of one of up to 200 bar and higher than 200 bar.

58. The light device of claim 53, wherein the light device is a metal halide discharge lamp.

59. The light device of claim 53, wherein the light device is an outside bulb into which a burner system is embedded.
